(19) United States
(12) Patent Application Publication
(10) Pub. No.: US 2017/0237885 A1
(43) Pub. Date: Aug. 17, 2017

(54) Method and Apparatus for High Contrast Imaging

(71) Applicant: Omnitek Partners LLC, Ronkonkoma, NY (US)

(72) Inventors: Harbans Dhadwal, Setauket, NY (US); Jahangir S. Rastegar, Stony Brook, NY (US); Dake Feng, Kings Park, NY (US)

(73) Assignee: Omnitek Partners LLC, Ronkonkoma, NY (US)

(21) Appl. No.: 15/279,256

(22) Filed: Sep. 28, 2016

Related U.S. Application Data
(60) Provisional application No. 62/233,988, filed on Sep. 28, 2015.

(51) Int. Cl. H04N 5/238; G02F 1/01; G03B 7/08; H04N 5/232; H04N 5/235; H04N 5/225

(52) U.S. Cl. CPC H04N 5/238; H04N 5/2351; H04N 5/2256; G03B 7/08; H04N 5/23293; H04N 5/2258; G02F 1/0126; G02F 2203/12

(57) ABSTRACT

An apparatus for improving contrast in an image captured by an imaging sensor. The apparatus including: an objective optical system positioned in an optical path of illumination light on an object; an image sensor positioned in the optical path such that light from the objective optical system is incident on the image sensor; a device having a variable transparency positioned at a focal plane of the objective optical system; and a processor configured to: detect a bright spot on the image sensor; and control the device to change a transparency of a portion of the device corresponding to the detected bright spot.

### CROSS-REFERENCE TO RELATED APPLICATION

This application claims the benefit to earlier filed U.S. Provisional Application No. 62/233,988 filed on Sep. 28, 2015, the entire contents of which is incorporated herein by reference.

### BACKGROUND OF THE INVENTION

1. Field of the Invention

The present invention relates generally to methods and devices for enhancing image contrast in the presence of bright background, and more particularly to image contrast enhancing methods and devices for the entire range of endoscopy, confocal endomicroscopy, and other similar devices used for imaging bright field objects, such as, human tissue, highly reflective semiconductor elements on wafers or MEM structures or the like.

2. Prior Art

High contrast imaging, in the presence of a bright background, is a challenging problem encountered in diverse applications ranging from the daily chore of driving into a sun-drenched scene to in vivo use of biomedical imaging in various types of keyhole surgeries, to low coherence interference microscopy to direct imaging of exoplanets in the back drop of star-to-planet brightness. Imaging in the presence of bright sources saturates the vision system, resulting in loss of scene fidelity, corresponding to low image contrast and reduced resolution. The problem is exacerbated in retro-reflective imaging systems where the light source(s) illuminating the object are unavoidably strong, typically masking the object features. The reflected bright light that is not originated from the features of the object being observed is background that is superimposed over the visual signal of interest and higher is the ratio of the background to the signal of interest, less differentiable will be the features of interest, i.e., the observed image contrast. Furthermore, the strength and direction of the background signal may vary over the entire object surface and may also be time dependent.

With respect to the current focus on biomedical imaging, low contrast of in vivo images is particularly acute and leads to unacceptably low confidence levels for real-time diagnosis of diseased tissue based on direct observation. Invariably, the patient is subjected to undergo biopsy, with a follow up visit, adding to health care cost, in addition to patient anxiety. In keyhole or other surgical procedures based on indirect observation via an image bundle, lack of high contrast images causes over estimation of excision margins resulting in unnecessary loss of healthy tissue.

Clearly, the scene, comprising of many objects or features, is invisible in the two extreme cases illumination, that is, intense light and no light. Most contemporary imaging systems heavily exploit digital signal processing algorithms to enhance the human vision experience by filling in lost image information, using interpolation techniques to improve spatial resolution and background subtraction based techniques for improving contrast. Most contemporary techniques seeking to improve image contrast are based on the use of a complex amplitude frequency plane mask, which assumes a linear response. Under this restrictive condition only contributions from collimated light sources perpendicular to the object and image planes can be eliminated, thus making minimal improvements in image contrast. Despite advances in precision optics, and in imaging sensors, the fact remains that the optical imaging front end, basically primitive and passive, has gone through evolutionary changes over the last century, but nothing extraordinary. Further, it should be noted that, no amount of digital signal processing can recover object detail lost due to low fidelity imaging, as a result of both detector saturation and low resolution imaging optics.

The imaging system is a complex, spatially invariant and non-linear system. Conventional analytical techniques, based on the spatial frequency response, are inadequate. Signal processing should be done directly in the optical space. The innovative approach, described in the following sections is based upon the notion that the optical energy emanating from any region of a scene has two components, one is the source of illumination and the second representing the interaction of the source energy with the localized object features. The word scene conveys the view of a three-dimensional space containing objects and boundaries that need to be imaged to another location.

FIG. 1 illustrates a conventional retro-reflective optical imaging system 100, typically used for opaque or translucent surfaces (O), such as human tissue. In general, the surface (O) is an integral part of the local features that are being imaged. Both respond to the incident illumination, contributing to the total light entering the imaging system 100. The total background signal comprises of disparate specular surfaces which redirect the illumination into an oblique cone of light beams (dash-dot, solid, dashed). Subsequently, local object features (O) are cloaked in a sea of intense background light, giving rise to a signal-to-background (SNB) ratio which is much smaller than unity. As illustrated, the poor object contrast, as described above, is relayed to an image sensor 102 at the image plane (I) without any expectation of improvement in the SNB. Image recording sensors capture the image with further addition of quantization noise. Digital processing techniques subtract the strong background to recover the local object features. However, as discussed above, such approaches are deficient and not able to recover the original object distribution.

Contemporary techniques, such as dark field imaging, reduce the amount of incident light entering the imaging optics, but do not improve the contrast as both background and object intensity are proportionally reduced. Other well established spatial filtering techniques, based on Fourier transforming properties of lenses, valid for paraxial (linear) optical systems 200, have demonstrated some gains, as illustrated in FIG. 2A. A mask M, with a dark spot at the origin D, selectively removes the background contribution arising from paraxial rays PR and subsequently the contrast of the image points I is much higher than that of the object points O.

However, FIG. 2B illustrates the shortcomings of a fixed Fourier plane mask technique, which is ineffective at removing contributions arising from oblique rays (OR). Thus, significant image contrast enhancements are precluded from being realized for practical systems falling outside the artificially imposed limitations of linearity (paraxial).

### SUMMARY

The present methods and devices represent a revolutionary opportunity for contrast enhancements in optical imaging systems and can be realized by recognizing that practical systems are shift-variant and non-linear.

An interactive/adaptive approach to enhance the image contrast by preventing the bright background optical energy reaching the image plane is provided, in which the imaging experience is described as a mosaic, whose every tile can be viewed under optimal conditions. An advantage of such technique is in its ability to locally increase image fidelity under white light conditions, as well as, monochromatic.

High fidelity imaging is achieved through adaptive control of one or more spatial light modulators (SLMs), positioned in the vicinity of the focal plane, adding a paradigm shifting dimension to in vivo optical imaging. Such methods and devices results in significant advantages, particularly in the field of biomedical imaging by providing a dynamic real time tool for clinicians to observe organs and tissue with the highest possible contrast. Such methods and devices can be incorporated into existing endoscopic systems or be manufactured as standalone high contrast imaging systems. Such methods and devices offer the only viable solution for observing objects against a very bright background. While in the adaptive mode the user has full control of the image contrast, however, it can also be implemented with pre-determined aperture stops in the frequency plane for imaging modalities that are not expected to changes, as might be the case for routine inspection of semiconductor wafers and other microelectromechanical (MEM) devices.

Accordingly, a method of improving contrast in an image captured by an imaging sensor is provided. The method comprising: placing an objective optical system in an optical path of illumination light on an object; detecting a bright spot at an image plane; and controlling a device positioned at a focal plane of the objective optical system to change a transparency of the device at a position corresponding to the bright spot on the image plane.

Subsequent to the controlling, the method can further comprise capturing image data at the image plane.

The detecting and controlled can be performed at predetermined intervals.

The method can further comprise displaying the image data to a user.

The transparency of the device can be controlled so as to be opaque at the position.

Also provided is an apparatus for improving contrast in an image captured by an imaging sensor. The apparatus comprising: an objective optical system positioned in an optical path of illumination light on an object; an image sensor positioned in the optical path such that light from the objective optical system is incident on the image sensor; a device having a variable transparency positioned at a focal plane of the objective optical system; and a processor configured to: detect a bright spot on the image sensor; and control the device to change a transparency of a portion of the device corresponding to the detected bright spot.

The image sensor can comprise a first image sensor, where the apparatus further comprising: a beam splitter positioned in the optical path between the device and the first image sensor; and a second image sensor positioned to receive incident light from a reflective surface of the beamsplitter.

### BRIEF DESCRIPTION OF THE DRAWINGS

These and other features, aspects, and advantages of the apparatus of the present invention will become better understood with regard to the following description, appended claims, and accompanying drawings where:

FIG. 1 illustrates an imaging system showing the presence of a bright background light from specular surfaces in an object plane in which incident illumination is not shown).

FIGS. 2A and 2B illustrate spatial filtering techniques used for pass filtering using a mask placed in the spatial frequency plane where FIG. 2A illustrates the mask effective for paraxial rays and FIG. 2B illustrates the mask ineffective for all oblique rays.

FIG. 3A illustrates an optical system for identifying spatial locations of oblique ray sources focal points.

FIG. 3B illustrates an optical system where information is coded into an SLM to subtract local or global source of bright background to obtain a high contrast image on an image sensor.

FIG. 4 illustrates the optical system of FIG. 3B with a feedback path to provide an automated contrast operation.

FIG. 5 illustrates an alternative embodiment of an optical system for obtaining a high contrast image in the presence of a bright background.

### DETAILED DESCRIPTION OF THE PREFERRED EMBODIMENT

It is understood that imaging can be performed at any suitable frequency and with the appropriate devices. Here for convenience, Applicants refer to the optical imaging system, that uses the visible and near infra-red spectral regions of the electromagnetic spectrum. Any arbitrary object is visible to the imaging system due to any number of physical attributes, such as, reflectivity, scattering or differential phase. The strength of the light intensity originating from the object and that originating from non-object features, are both dependent on the strength of the incident illumination. The goal of any imaging system is to capture as much of the light from the object features while minimizing the background light from entering the imaging system. In practice, it is not possible to reduce one without the other, resulting in poor object visibility due to the bright background. Contrast of the recorded image is further degraded due to the finite resolution of the image detection and recording system. As an example of the image contrast problem, features etched into shiny surfaces, such as silicon wafers, define the boundaries of the object, while flat shiny surfaces are the non-object features giving rise to the background light.

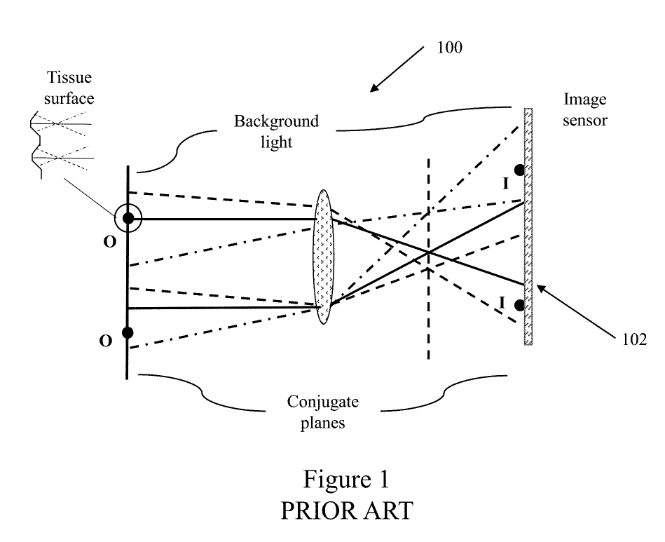

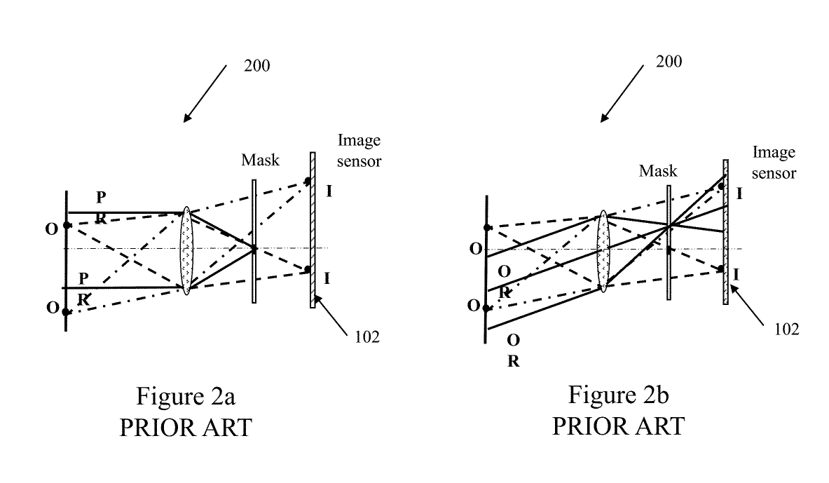

The background signal can either be of a global specular nature, giving rise to parallel illumination from the entire object surface or can be represented by a mosaic of randomly orientated, small specular surfaces. The latter is more representative of real world practical imaging systems. For example, such surfaces describe human tissue being observed in body cavities or other similar closed enclosures, where illumination light is introduced along the same path as the imaging. Thus, the background signal comprises of groups of oblique rays corresponding to distributions of the mosaic surfaces as illustrated in FIG. 1. Through the imaging system, each group of like surface casts a local bright light spot in the image plane. Superposition of the bright spots originating from the disparate groups of surfaces in the object plane (O) give rise to a composite bright background in the image plane (I). Light intensity from the object features, appears as an intensity modulation, riding on top of a very large background light intensity. In the typical image conditions considered here, the ratio of the modulated signal to the stronger background signal, defined as the signal-to-background ratio (SNB), is much smaller than unity. Under such imaging conditions, the gain of the image detector can be adjusted to avoid saturation, however at the lower gain settings the imaging detector cannot see the modulation, resulting in loss of object information.

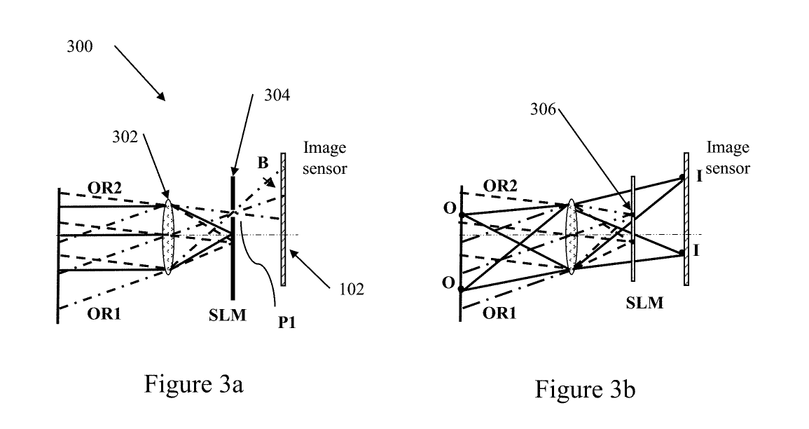

The present methods and devices utilize paradigm shifting approach, illustrated in FIGS. 3A and 3B, which result in high-fidelity imaging under practical illumination conditions. The optical system of FIGS. 3A and 3b is generally referred to by reference numeral 300 and includes an objective optical system 302 having one or more objective lenses.

Implementation of the proposed approach begins by identifying the object domain origins of the bright regions B, in the image space. With reference to FIG. 3A, a device having a variable transparency, such as a programmable spatial light modulator (SLM) 304, which can be a liquid crystal device, placed in the focal plane F enables discovery of the background sources. With the SLM in 100% transparent mode, a low contrast image provides the initial location of the bright sources. Essentially, any localized concentration of light P1 in the focal plane correlates with a particular set of oblique rays OR1 emanating from the object plane. In the image plane these oblique rays give rise to a local bright region B. Knowledge of the optical image system can be combined with the measured distribution of the bright region B by the image recording device to determine the location of the corresponding pixels at P1 of the SLM. Multiple bright regions can be identified with a single measurement of the intensity by the image recording device. Further improvement in the location of the pixels in the SLM is possible by changing the transparency of all other pixels to zero percent allowing interrogation of individual bright regions. It can be appreciated, that this process can be repeated, leading to a complete mapping of the origins of the background light intensity. As depicted in FIG. 3B, the SLM is controlled through a controller, such as a CPU, to subtract the background light contributions from multiple oblique rays at the locations on the focal plane (F) corresponding to the locations of localized concentration of light (P1). Those skilled in the art will recognize that methods for detecting concentration of light at the SLM and/or at the image sensor are well known in the art.

Once P1 is detected, the SLM 304 can be controlled to change its transparency at P1 to be partially or completely opaque, as is illustrated at points 306 in FIG. 3B. Thus, as depicted in FIG. 3B, the background intensity has been removed entirely from the image area HI of the image sensor 102, which now has an image with 100% modulation, that is, the highest possible image contrast that can be displayed to the user on the monitor/display 312. The image sensor can be a CCD or CMOS sensor or the like.

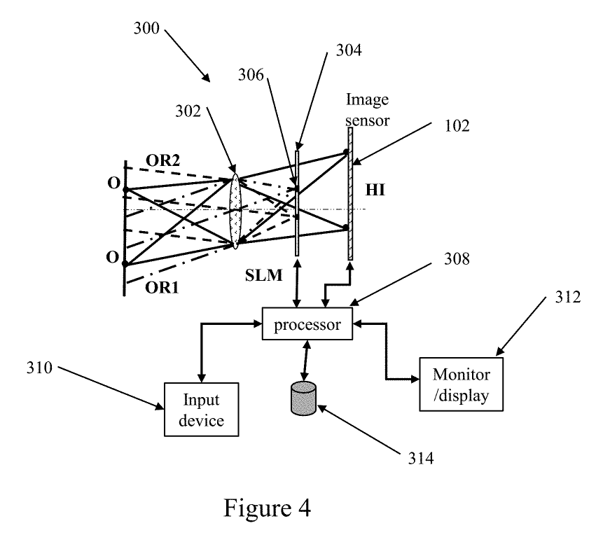

FIG. 4 shows an embodiment, with a feedback path, that allows for continuous tracking and updating of the background signals that are not time stationary. Continuous updating allows for contrast enhancement of video imaging. Thus, a hardware processor 308, such as a CPU, is used to continuously monitor (at predetermined intervals) the presence of localized concentrations of light at the SLM 304 and to control the SLM 304 to change the transparency of a predetermined portion of the SLM 304 sufficient to produce a high contrast image to a degree that is suitable to an end-user. Alternatively or in addition, the processor 308 can monitor the image sensor 102 for low contrast portions and control the SLM 304 accordingly. The optical system 300 can be passive without any user input or, alternatively, the processor 102 can receive user input, through an input device 310 such as a keyboard, mouse, joystick, touchscreen or the like, as to an acceptable level of contrast in the resulting image/video (e.g., low, medium or high contrast images) or to remove control of the SLM altogether to maintain a state of 100% transparency regardless of the presence of bright background. A storage device 314 can also be provided for storing such user input variables and/or a set of instructions for carrying out the methods described above.

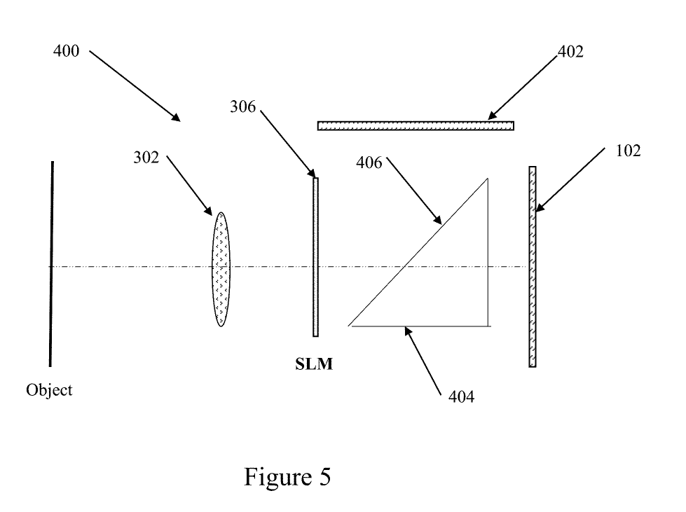

Turning next to FIG. 5, the same illustrates an alternative embodiment of an optical system, generally referred to by reference number 400, in which a second image sensor 402 and beam splitter 404 are added to the embodiment of FIG. 4 (although FIG. 5 does not illustrate the processor, monitor, storage device and input device of FIG. 4, the optical system of FIG. 5 can be similarly configured with the same). In the optical system 400 of FIG. 5, an image of the object (e.g., body tissue) is formed on both the first image sensor 102 and the second image sensor 402 by virtue of the beam splitting properties of the beam splitter 404. Those skilled in the art will appreciate that surface 406 of the beam splitter is such that some of the incident light will pass through to image sensor 102 and some of the incident light will be reflected to the second image sensor 402. In this case, one of the image sensors is used to detect the bright spots (e.g., image sensor 102) in an image and/or video incident thereon and the SLM 306 controlled accordingly as discussed above to produce a high-contrast image/video on the other image sensor (e.g., image sensor 402), which is displayed to the user.

While there has been shown and described what is considered to be preferred embodiments of the invention, it will, of course, be understood that various modifications and changes in form or detail could readily be made without departing from the spirit of the invention. It is therefore intended that the invention be not limited to the exact forms described and illustrated, but should be constructed to cover all modifications that may fall within the scope of the appended claims.

What is claimed is:

1. A method of improving contrast in an image captured by an imaging sensor, the method comprising:
placing an objective optical system in an optical path of illumination light on an object;
detecting a bright spot at an image plane; and
controlling a device positioned at a focal plane of the objective optical system to change a transparency of the device at a position corresponding to the bright spot on the image plane.

2. The method of claim 1, subsequent to the controlling, further comprising capturing image data at the image plane.

3. The method of claim 1, wherein the detecting and controlled are performed at predetermined intervals.

4. The method of claim 2, further comprising displaying the image data to a user.

5. The method of claim 1, wherein the transparency of the device is controlled so as to be opaque at the position.

6. An apparatus for improving contrast in an image captured by an imaging sensor, the apparatus comprising:
an objective optical system positioned in an optical path of illumination light on an object;
an image sensor positioned in the optical path such that light from the objective optical system is incident on the image sensor;
a device having a variable transparency positioned at a focal plane of the objective optical system; and
a processor configured to:
detect a bright spot on the image sensor; and
control the device to change a transparency of a portion of the device corresponding to the detected bright spot.

7. The apparatus of claim 6, wherein the image sensor comprises a first image sensor, the apparatus further comprising:
a beam splitter positioned in the optical path between the device and the first image sensor; and
a second image sensor positioned to receive incident light from a reflective surface of the beamsplitter.
